(19) United States
(12) Patent Application Publication
(10) Pub. No.: US 2016/0308190 A1
(43) Pub. Date: Oct. 20, 2016

(54) ELECTRIC STORAGE DEVICE COMPRISING CURRENT INTERRUPTION DEVICE

(71) Applicant: KABUSHIKI KAISHA TOYOTA JIDOSHOKKI, Kariya-shi (JP)

(72) Inventors: Motoaki OKUDA, Kariya-shi (JP); Takayuki HIROSE, Kariya-shi (JP); Hiroyasu NISHIHARA, Kariya-shi (JP)

(73) Assignee: KABUSHIKI KAISHA TOYOTA JIDOSHOKKI, Kariya-shi (JP)

(21) Appl. No.: 15/101,576

(22) PCT Filed: Nov. 28, 2014
(86) PCT No.: PCT/JP2014/081607

§ 371 Date: Jun. 3, 2016

(30) Foreign Application Priority Data
Dec. 13, 2013 (JP) 2013-257981

(51) Int. Cl. H01M 2/34; H01G 9/008; H01M 10/04; H01M 2/14; H01M 2/26; H01G 9/08; H01G 9/18

(52) U.S. Cl. CPC H01M 2/345; H01G 9/08; H01G 9/008; H01G 9/18; H01M 2/14; H01M 2/26; H01M 10/0431; H01M 2200/20

(57) ABSTRACT

An electric storage device disclosed in the present application includes a casing, a first electrode terminal and a second electrode terminal that are provided on a terminal attachment wall of the casing, and an electrode assembly, a first conductive member, a second conductive member, and a current interruption device that are disposed within the casing. The first conductive member and the second conductive member connected respectively to a positive electrode or a negative electrode of the electrode assembly. The current interruption device is arranged between the terminal attachment wall and the electrode assembly, connected in series between the first electrode terminal and the first conductive member, and configured to connect or interrupt a conductive path from the electrode assembly to the first electrode terminal. A first spacer is further provided between the current interruption device and the electrode assembly, the first spacer being in contact with the electrode assembly.

### TECHNICAL FIELD

This application claims priority to Japanese Patent Application No. 2013-257981 filed on Dec. 13, 2013, the entire contents of which are hereby incorporated by reference into the present application. The present invention relates to an electric storage device comprising a current interruption device.

### BACKGROUND ART

Japanese Patent Application Publication No. 2012-119183 discloses a lithium-based battery including a pressure-detecting current interruption device. In this battery, a positive-electrode terminal and a negative-electrode terminal are attached to a wall on a same side of a casing, and the current interruption device is provided substantially below the positive-electrode terminal (on an electrode assembly side). The current interruption device is connected in series between a conductive member that is connected to a positive electrode of an electrode assembly and the positive-electrode terminal. A rise in pressure inside the casing of the battery causes a deforming plate of the current interruption device to be deformed to interrupt a conductive path from the positive electrode to the positive-electrode terminal.

### SUMMARY OF INVENTION

### Technical Problem

In a process of manufacturing an electric storage device in which a positive-electrode terminal and a negative-electrode terminal are both provided on one terminal attachment wall and a current interruption device is arranged between an electrode assembly and the terminal attachment wall, when in a state where the electrode assembly, the conductive member, the current interruption device, and the electrode terminals are connected to one another, all of these are inserted into a casing so that the electrode assembly side faces a bottom surface side of the casing (i.e., a surface side opposed to the terminal attachment wall), friction between the electrode assembly and an inner wall of the casing causes reaction force to be generated in a direction opposite to the direction of insertion. Normally, since there is a gap between the electrode assembly and the current interruption device, this reaction force may cause bending moment to be generated in the conductive member. If this bending moment is transmitted via the conductive member to a fragile part of the current interruption device that switches between conduction and interruption, the current interruption device may be caused to malfunction to interrupt the conductive path. The present application aims to provide an electric storage device that is capable of suppressing the generation of bending moment in a first conductive member for example when an electrode assembly is inserted into a casing and, as a result, restraining an current interruption device from malfunctioning.

### Solution to Technical Problem

An electric storage device disclosed herein comprises a casing, an electrode assembly disposed within the casing and comprising a positive electrode and a negative electrode, a first electrode terminal and a second electrode terminal that are provided on a terminal attachment wall of the casing, a first conductive member disposed within the casing and electrically connected to an electrode of one polarity of the electrode assembly, a second conductive member disposed within the casing and electrically connected to both an electrode of the other polarity of the electrode assembly and the second electrode terminal, and a current interruption device disposed within the casing, connected in series between the first electrode terminal and the first conductive member, and configured to connect or interrupt a conductive path from the electrode assembly to the first electrode terminal. The current interruption device is arranged between the terminal attachment wall and the electrode assembly. A first spacer is further provided between the current interruption device and the electrode assembly, the first spacer being in contact with the electrode assembly.

In the electric storage device, the first spacer is further provided between the current interruption device and the electrode assembly, the first spacer being in contact with the electrode assembly. By the first spacer making contact with the electrode assembly, the gap between the current interruption device and the electrode assembly is eliminated, thereby making it possible to restrain the bending moment from being generated in the first conductive member by friction or the like that is generated when the electrode assembly is inserted into the casing. This accordingly makes it possible to restrain the current interruption device from malfunctioning to interrupt the conductive path.

In the above electric storage device, the first spacer may be fixed to the current interruption device.

In the above electric storage device, the first spacer may comprise a surface which makes contact with the electrode assembly, the surface may have a shape corresponding to a shape of a surface of the electrode assembly on a first spacer side.

The above electric storage device may further comprise a second spacer arranged between the second electrode terminal and the electrode assembly. Further, the second spacer may be fixed to the second electrode terminal. Further, the second spacer may comprise a surface which makes contact with the electrode assembly, the surface may have a shape corresponding to a shape of a surface of the electrode assembly on a second spacer side.

The above electric storage device may further comprise a shock-absorber arranged between the electrode assembly and a wall surface opposed to the terminal attachment wall of the casing.

The above electric storage device may be a secondary battery.

### BRIEF DESCRIPTION OF DRAWINGS

FIG. 1 is a vertical cross-sectional view of an electric storage device according to Embodiment 1;

FIG. 2 is a cross-sectional view taken along line II-II in FIG. 1;

FIG. 3 is a conceptual diagram of an electrode assembly having a wound structure shown in FIG. 1;

FIG. 4 is an enlarged view of a first spacer shown in FIG. 1;

FIG. 5 is an enlarged view of a second spacer shown in FIG. 1;

FIG. 6 is an enlarged view of a current interruption device shown in FIG. 1 and an area therearound with an electric storage device in a normally-operating state;

FIG. 7 is an enlarged view of the current interruption device shown in FIG. 1 and the area therearound with the electric storage device in an overcharged state;

FIG. 8 is an enlarged view of a current interruption device according to a modification and an area therearound with an electric storage device in a normally-operating state;

FIG. 9 is an enlarged view of the current interruption device according to the modification and the area therearound with the electric storage device in an overcharged state; and

FIG. 10 is a vertical cross-sectional view of an electric storage device according to a modification.

### DESCRIPTION OF EMBODIMENTS

An electric storage device disclosed herein may be utilized, for example, as a conventional publicly-known electric storage device such as a sealed secondary battery or a sealed capacitor. Further specific examples of secondary batteries may be secondary batteries having comparatively large capacity and performing charge and discharge of large current, such as a lithium-ion battery, a nickel-metal-hydride battery, a nickel-cadmium battery, and a lead storage battery. Further, the electric storage device may be mounted in a vehicle, an electrical apparatus, or the like.

An electric storage device disclosed herein comprises: a casing; an electrode assembly disposed within the casing; a first conductive member disposed within the casing; a second conductive member disposed within the casing; a current interruption device disposed within the casing; and a first electrode terminal and a second electrode terminal that are provided on a terminal attachment wall of the casing. The current interruption device is arranged between the terminal attachment wall and the electrode assembly. The electric storage device further comprises a first spacer provided between the current interruption device and the electrode assembly, the first spacer being in contact with the electrode assembly. The first spacer may be fixed to the current interruption device. For example, the first spacer and the current interruption device may be fixed in a state of being in contact with each other, or may be fixed to each other via another member (e.g., the first conductive member).

The electrode assembly comprises a positive electrode and a negative electrode. A possible example of the electrode assembly is an electrode assembly comprising a pair of electrodes in which a sheeted positive electrode and a sheeted negative electrode form layers with a sheeted separator interposed therebetween. More specific examples of the electrode assembly are a laminated electrode assembly in which a large number of these pairs of electrodes are laminated and a wound electrode assembly in which this pair of electrodes is wound around a predetermined axis. On an outermost side of the electrode assembly, either the positive electrode or the negative electrode may be arranged, or the separator may be arranged. Further, the electrode assembly may be immersed in an electrolyte.

The first conductive member is electrically connected to an electrode of one polarity of the electrode assembly. The current interruption device is connected in series between the first electrode terminal and the first conductive member. The second conductive member is electrically connected to both an electrode of the other polarity of the electrode assembly and the second electrode terminal. In a case where the first conductive member is connected to the positive electrode, the current interruption device is placed on a positive-electrode-side conductive path (i.e., a conductive path from the positive electrode of the electrode assembly to the first electrode terminal), and the second conductive member is connected to both the negative electrode of the electrode assembly and the negative-electrode terminal. In a case where the first conductive member is connected to the negative electrode of the electrode assembly, the current interruption device is placed on a negative-electrode-side conductive path (i.e., a conductive path from the negative electrode of the electrode assembly to the first electrode terminal), and the second conductive member is connected to both the positive electrode of the electrode assembly and the positive-electrode terminal. The current interruption device connects or interrupts the conductive path from the electrode assembly to the first electrode terminal. The current interruption device may constitute a part of the conductive path from the electrode assembly to the first electrode terminal. More specifically, for example, a conductive path from a first electrode (i.e., positive electrode or negative electrode) corresponding to the first electrode terminal of the electrode assembly to the first electrode terminal may be electrically connected via the first conductive member and the current interruption device, which are connected in series in this order.

A surface of the first spacer which makes contact with the electrode assembly may have a shape corresponding to a shape of a surface of the electrode assembly on a first spacer side. The term “corresponding” here means that the surfaces have similar or complementary shapes that allow them to make contact with each other over a wider area. In a case where the surface of the electrode assembly on the first spacer side is flat, it is preferable that the shape of the surface of the first spacer which makes contact with the electrode assembly be similarly flat. Alternatively, in a case where the surface of the electrode assembly on the first spacer side is an R-shaped convex surface, it is preferable that the shape of the surface of the first spacer which makes contact with the electrode assembly be a complementary shape, i.e., an R-shaped concave surface having a similar curvature. When the surfaces of the first spacer and the electrode assembly which make contact with each other have shapes corresponding to each other, the surfaces that make contact with each other come to have a larger area, allowing a reduction in contact surface pressure.

It is preferable that the first spacer and the surface of the electrode assembly which makes contact with the first spacer be insulated from each other. An insulation may be achieved, for example, by arranging an insulating separator on an outermost circumference of the electrode assembly so that the surface of the electrode assembly which is in contact with the first spacer may function as the separator, by using an insulating material to form the surface of the first spacer which makes contact with the electrode assembly, and/or by using an insulating material to form the entire first spacer. As the insulating material, an insulating material that has conventionally been used in the field of electric storage devices may be used, and on the first spacer side, a resin material such as polypropylene or polyethylene may be suitably used.

The electric storage device may further comprise a second spacer arranged between the second electrode terminal and the electrode assembly, the second spacer being in contact with the electrode assembly. This brings about an effect of suppressing the generation of bending moment on a second conductive member side, in addition to the effect of restraining bending moment from being generated on a first conductive member side by reaction force or the like that is generated when the electrode assembly 60 is inserted into the casing 1. Further, when inserting the electrode assembly into the casing, the electrode assembly can be uniformly pushed in by both the first spacer and the second spacer. The second spacer may be fixed to the second electrode terminal.

As in the case of the first spacer, a surface of the second spacer which makes contact with the electrode assembly may have a shape corresponding to a shape of a surface of the electrode assembly on a second spacer side. As in the case of the description of the first spacer, when the surfaces of the second spacer and the electrode assembly which make contact with each other have shapes corresponding to each other, the surfaces that make contact with each other come to have a larger area, allowing a reduction in contact surface pressure.

Further, as in the case of the first spacer, it is preferable that the second spacer and the surface of the electrode assembly which makes contact with the second spacer be insulated from each other. The second spacer and the surface of the electrode assembly which is in contact with the second spacer can be insulated from each other by a means which is similar to that used for the first spacer.

The electric storage device may further comprise a shock-absorber arranged between the electrode assembly and a wall surface opposed to the terminal attachment wall of the casing. Even when the electrode assembly is deeply inserted into the casing at the time of the electrode assembly being inserted into the casing, the electrode assembly makes contact with the shock-absorber, not the wall surface opposed to the terminal attachment wall of the casing. Making contact with the shock-absorber allows a relaxation of the reaction force that is generated when the electrode assembly is inserted (i.e., the force that acts in a direction opposite to the direction of insertion).

### Embodiment 1

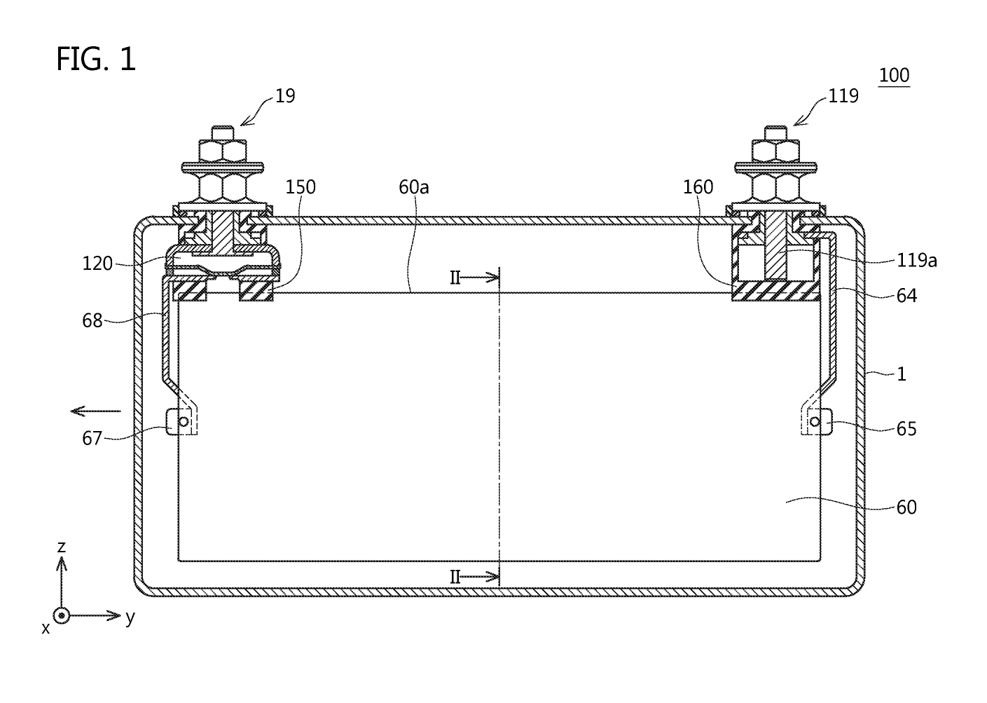

FIG. 1 is a cross-sectional view of an electric storage device 100 according to Embodiment 1. The electric storage device 100 comprises a casing 1, a wound-type electrode assembly 60, a first conductive member 68, a second conductive member 64, a first electrode terminal 19, a second electrode terminal 119, a current interruption device 120, a first spacer 150, and a second spacer 160. For the sake of convenience, the following description may assume that an upper side is a positive direction side of a z axis and a lower side is a negative direction side of the z axis.

The casing 1 is a box-shaped member having a substantially cuboidal shape, and accommodates the electrode assembly 60, an electrolytic solution (not illustrated), the first conductive member 68, the second conductive member 64, the current interruption device 120, the first spacer 150, and the second spacer 160. An upper end surface of the casing 1 (i.e., a surface facing in the positive direction of the z axis) is a terminal attachment wall to which the first electrode terminal 19 and the second electrode terminal 119 are attached. The first electrode terminal 19 is electrically connected to a negative electrode of the electrode assembly 60, and the second electrode terminal 119 is electrically connected to a positive electrode of the electrode assembly 60.

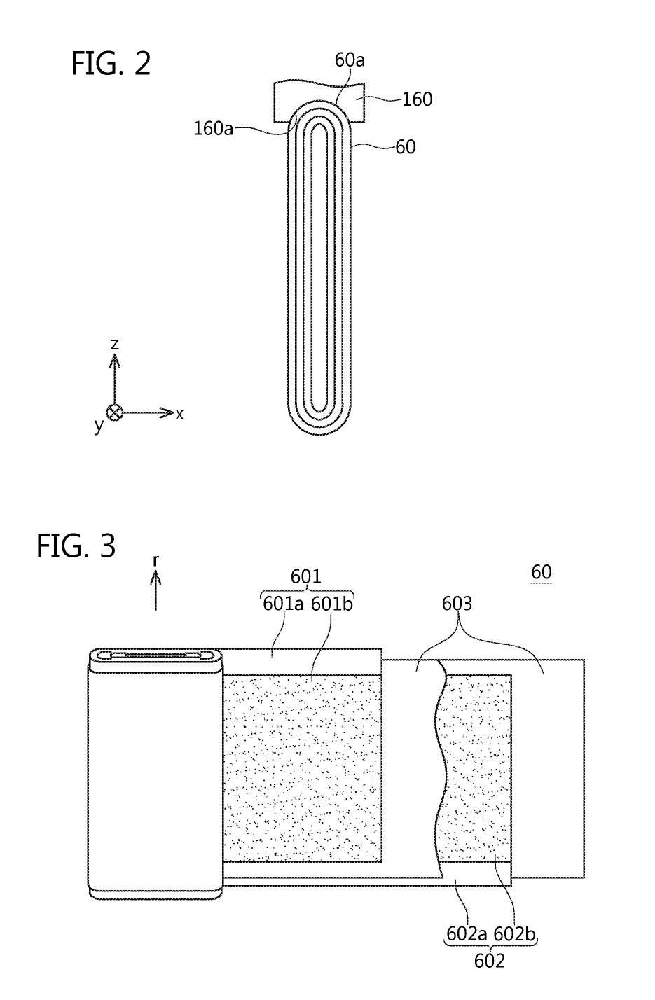

As shown in FIGS. 2 and 3, the electrode assembly 60 comprises a pair of electrodes in which a positive-electrode sheet 601, a separator 603, a negative-electrode sheet 602, and another separator 603 are laminated in this order, and the pair of electrodes are wound around a winding axis (which is an r axis shown in FIGS. 1 and 3) placing a positive-electrode sheet 601 side on an inner side. The positive-electrode sheet 601 comprises a positive-electrode metal sheet 601a made of aluminum and a positive-electrode active substance layer 601b arranged on both surfaces of the positive-electrode metal sheet 601a. The negative-electrode sheet 602 comprises a negative-electrode metal sheet 602a made of copper and a negative-electrode active substance layer 602b arranged on both surfaces of the negative-electrode metal sheet 602a. The separators 603 are an insulating porous body. The electrode assembly 60 is disposed within the casing 1 in a state of being impregnated with liquid electrolyte. The r axis, which is a winding axis of a wound structural body, is substantially parallel to a y axis, and the first electrode terminal 19 and the second electrode terminal 119 are arranged at both ends, respectively, of the terminal attachment wall along a direction of the r axis.

The first conductive member 68 comprises a current collector 67, and the negative-electrode sheet 602 of the electrode assembly 60 is bundled by the current collector 67. The second conductive member 64 comprises a current collector 65, and the positive-electrode sheet 601 of the electrode assembly 60 is bundled by the current collector 65.

As shown in FIG. 1, the first conductive member 68 has a shape formed by bending a flat plate made of copper or a copper alloy. The first conductive member 68 extends in a negative direction of the y axis below the first electrode 19, bends, and extends in a negative direction of the z axis.

As shown in FIGS. 1 and 2, an upper surface 60a of the electrode assembly 60 is an R-shaped surface that is convex toward the terminal attachment wall (in the positive direction of the z axis). At both ends of the surface 60a in the y direction, the first spacer 150 and the second spacer 160 are in contact with the electrode assembly 60.

The current interruption device 120 is connected to the first conductive member 68 at a lower surface side of the current interruption device 120 and connected to the first electrode terminal 19 at an upper surface side of the current interruption device 120. Further, the first electrode terminal 19 and the first conductive member 68 are electrically connected to each other via the current interruption device 120. Thus, a negative-electrode-side conductive path from the negative-electrode sheet 602 of the electrode assembly 60 to the first electrode terminal 19 is connected via the first conductive member 68 and the current interruption device 120, which are connected in series in this order.

The second conductive member 64 has a shape formed by bending a flat plate made of aluminum. The second conductive member 64 extends in a positive direction of the y axis below the second electrode terminal 119, bends, and extends in the negative direction of the z axis. A positive-electrode-side conductive path from the positive-electrode sheet 601 of the electrode assembly 60 to the second electrode terminal 119 is connected via the second conductive member 64. The electric storage device 100 is capable of exchanging electricity with the electrode assembly 60 and an outer part of the casing 1 via the first electrode terminal 19 and the second electrode terminal 119. It should be noted that the second conductive member 64 is not necessarily meant to be a single member. A plurality of conductive members may be connected to constitute the second conductive member 64.

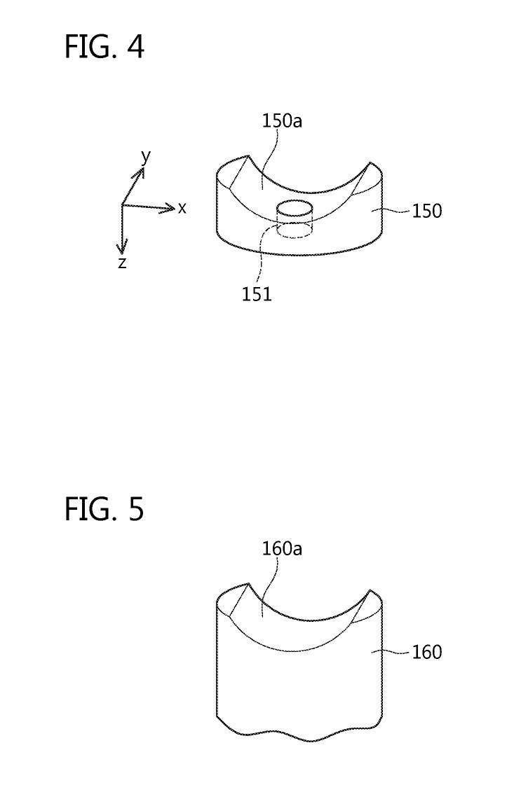

As shown in FIG. 4, the first spacer 150 has a shape formed by cutting one circular surface side of a substantially columnar member into an R-shape. The first spacer 150 is fixed to the current interruption device 120 so that an R-shaped surface 150a faces the electrode assembly 60 (in the negative direction of the z axis). The surface 150a is a surface that makes contact with the electrode assembly 60, and has a concave R-shape (which has about the same curvature as the surface 60a) which is concave to a terminal attachment wall side so as to correspond to a shape of a surface (surface 60a) of the electrode assembly 60 on a first spacer 150 side. The first spacer 150 is provided with a through-hole 151 that passes through the first spacer 150 in the z direction.

As shown in FIG. 5, the second spacer 160 has a shape formed by cutting one circular surface side of a substantially columnar member into an R-shape. The second spacer 160 is fixed to the second electrode terminal 119 so that an R-shaped surface 160a faces the electrode assembly 60. The second spacer 160 is a hollow member, and the second electrode terminal 119 has a bolt 119a that extends into contact with an inner bottom surface of the second spacer 160. The second spacer 160 engages with the terminal attachment wall of the casing 1 at an upper part the second spacer 160 and is fixed to the second electrode terminal 119 and the terminal attachment wall. The surface 160a is a surface that makes contact with the electrode assembly 60, and has a concave R-shape (which has about the same curvature as the surface 60a) which is concave to the terminal attachment wall side so as to correspond to a shape of a surface (surface 60a) of the electrode assembly 60 on a second spacer 160 side. The first spacer 150 and the second spacer 160 are made of an insulating resin material.

FIG. 2 shows a state in which the surface 160a of the second spacer 160 and the surface 60a of the electrode assembly 60 on the second spacer side are in contact with each other. The surface 60a has a convex R-shape which is convex to the terminal attachment wall side, and the surface 160a has a concave R-shape which is concave to the terminal attachment wall side so as to correspond to the shape of the surface 60a. This allows entireties of the surface 160a and the surface 60 to make contact with each other over a larger area of contact, allowing a reduction in contact surface pressure. Although not illustrated, the surface 150a of the first spacer 150 similarly has a shape corresponding to the shape of the surface of the electrode assembly 60 on the first spacer 150 side. This also allows the surface 150a and the surface of the electrode assembly 60 on the first spacer 150 side to make contact with each other over a larger area of contact, allowing a reduction in contact surface pressure.

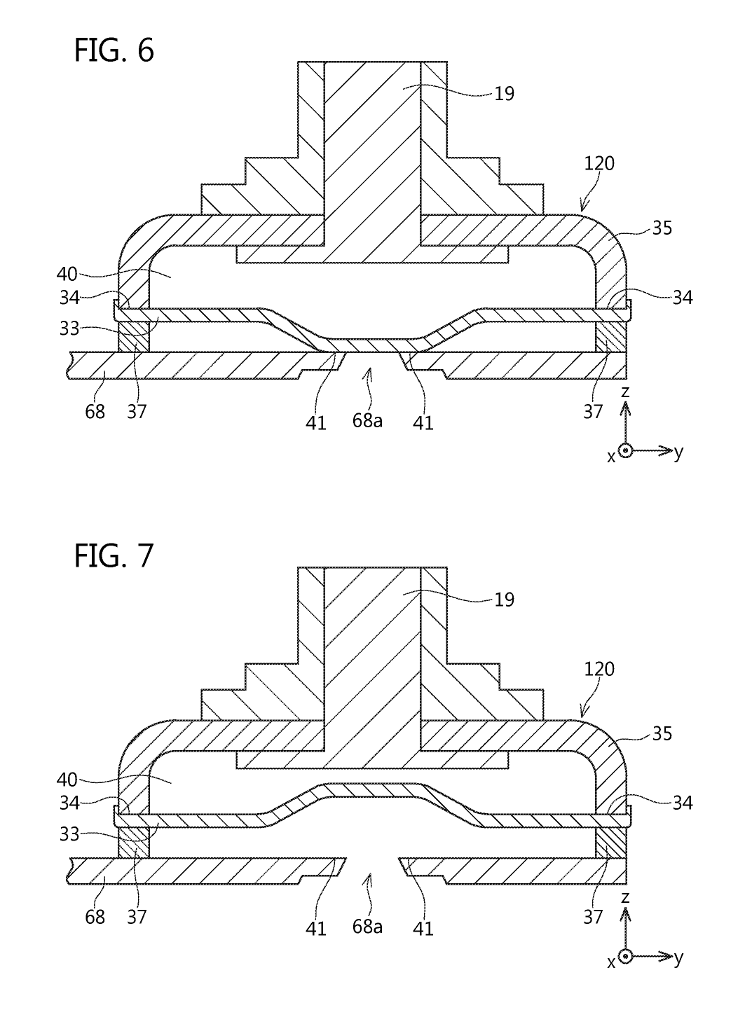

As shown in FIG. 6, the current interruption device 120 comprises a deforming plate 33, a contact plate 35, and an annular member 37. The deforming plate 33 is a diaphragm made of copper or a copper alloy. The deforming plate 33 is a circular substantially flat-plate member in a plan view and has a truncated conical convex part in a central part thereof. During normal operation of the electric storage device 100, the convex part of the deforming plate 33 is convex toward a side on which the first conductive member 68 and the electrode assembly 60 are arranged (in the negative direction of the z axis). The contact plate 35 is a circular substantially flat-plate member made of metal in a plan view. The contact plate 35 has a flat-plate central part and a side surface part that extends from the central part toward the deforming plate 33 in a curve. The annular member 37 is a member shaped like a ring in a plan view. The deforming plate 33 and the contact plate 35 are in contact with each other at a connection part 34 and fixed to each other by welding. The deforming plate 33 and the contact plate 35 form a wall that separates a space 40 from an electrode assembly 60 side within the casing 1, and an upper surface of the deforming plate 33 (i.e., a surface of the positive direction side of the z axis) and a lower surface of the contact plate 35 (i.e., a surface of the negative direction side of the z axis) face the space 40.

The contact plate 35 is in contact with and fixed to the first electrode terminal 19 by welding. The deforming plate 33 is fixed to the annular member 37 and the contact plate 35 by welding in a state of being interposed between the annular member 37 and the contact plate 35. Furthermore, the deforming plate 33 is in contact with the first conductive member 68 at a bonding part 41 and welded to the first conductive member 68. The first conductive member 68 has a circular hole 68a formed along a circular lower surface of the convex part of the deforming plate 33, and the bonding part 41 is located around the hole 68a. The annular member 37 is fixed to the first conductive member 68 by an insulating adhesive such as a silicon-based adhesive in a state of being insulated from the first conductive member 68. The first conductive member 68, the deforming plate 33, and the contact plate 35 are connected in series in this order from the electrode assembly 60 toward the first electrode terminal 19 to constitute the negative-electrode-side conductive path. The first spacer 150 is fixed to a lower part of the first conductive member 68 by an adhesive or the like so that the through-hole 151 lies directly below the hole 68a (in the negative direction of the z axis). The first spacer 150 is in a state of being fixed to the current interruption device 120 via the first conductive member 68.

As shown in FIG. 7, when pressure on the electrode assembly 60 side within the casing 1 rises and pressure on a space 40 side with respect to a casing 1 side becomes negative, the deforming plate 33 becomes inverted in a direction away from the first conductive member 68 (in the positive direction of the z axis), as the upper surface of the deforming plate 33 faces the space 40 and the lower surface of the deforming plate 33 faces the electrode assembly 60 side within the casing 1 via the through-hole 151. When the deforming plate 33 is inverted and the bonding part 41 is detached from the first conductive member 68, the negative-electrode-side conductive path is interrupted.

In the process of manufacturing the electric storage device 100, when in a state where the electrode assembly 60, the first conductive member 68, the current interruption device 120, and the first electrode terminal 19 are connected to one another, all of these are inserted into the casing 1 so that the electrode assembly 60 side faces a bottom surface side of the casing 1 (i.e., a surface side opposed to the terminal attachment wall), friction between the electrode assembly and an inner wall of the casing causes reaction force to act in a direction (positive direction of the z axis) opposite to the direction of insertion (negative direction of the z axis). When there is a gap between the electrode assembly 60 and the current interruption device 120, this reaction force may cause bending moment to be generated in the first conductive member 68. If this bending moment is transmitted to the current interruption device 120 via the first conductive member 68, a load may be applied to a fragile part of the current interruption device 120 that switches between conduction and interruption (i.e., the bonding part 41 at which the deforming part 33 and the first conductive member 68 are welded to each other) and consequently cause the current interruption device 120 to malfunction to interrupt the negative-electrode-side conductive path.

In the electric storage device 100, the first spacer 150, which is in contact with the electrode assembly 60, is provided between the current interruption device 120 and the electrode assembly 60. The contact of the first space 150 with the electrode assembly 60 eliminates the gap between the current interruption device 120 and the electrode assembly 60, thereby making it possible to restrain bending moment from being generated in the first conductive member 68 by friction or the like that is generated when the electrode assembly 60 is inserted into the casing 1. This makes it possible to restrain the current interruption device 120 from malfunctioning to interrupt the negative-electrode-side conductive path.

Further, the electric storage device 100 comprises the second spacer 160, which is in contact with the electrode assembly 60, arranged between the second electrode terminal 119 and the electrode assembly 60. This arrangement restrains bending moment from being generated on a second conductive member 64 side by reaction force or the like that is generated when the electrode assembly 60 is inserted into the casing 1. Further, when the electrode assembly 60 is inserted into the casing 1, the electrode assembly 60 can be uniformly pushed in by both the first spacer 150 and the second spacer 160.

### Modifications

In the embodiment described above, the casing 1 is a box-shaped member having a substantially cuboidal shape. Alternatively, for example, the casing may be a box-shaped member having a substantially cylindrical shape.

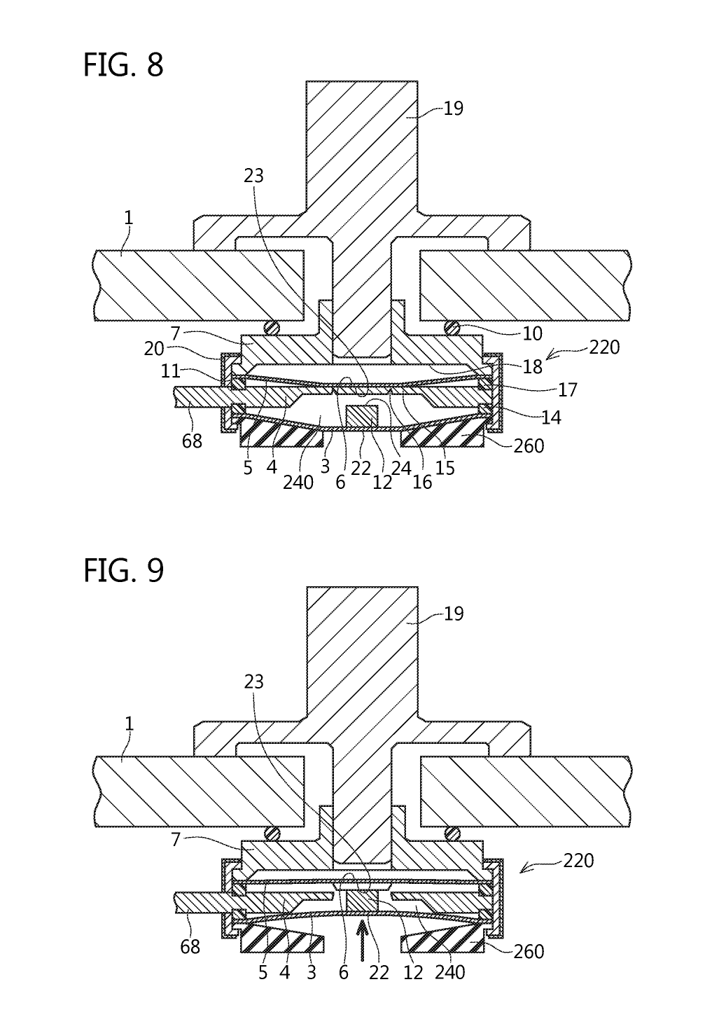

Further, in the embodiment described above, the current interruption device 120 is configured such that one surface of the deforming plate 33, which has the bonding part 41, is exposed to pressure inside the casing 1 and becomes inverted in a case where the pressure inside the casing 1 rises and a difference in pressure between both surfaces of the deforming plate 33 becomes equal to or greater than a predetermined value. However, this does not imply any limitation. For example, alternatively, the conductive path may be interrupted as in the following manner: as in the case of a current interruption device 220 described below with reference to FIGS. 8 and 9, a first deforming plate 5 (which is an example of a deforming plate) joined to the first conductive member 68 may be deformed in response to a load that is applied by a second deforming plate 3 (which is an example of a deforming plate) that becomes inverted when the pressure inside the casing 1 rises and consequently the conductive path is interrupted. Further, a joined member (e.g., the first conductive member) that is joined to the deforming plate may be one that is cut off while maintaining the joint, instead of being divided by detachment at the time of current interruption. It should be noted that in the description of the modification with reference to FIGS. 8 and 9 below, only components that are different from those of the electric storage device 100 according to Embodiment 1 will be described, and descriptions of components that are identical to those of the electric storage device 100 will be omitted.

The current interruption device 220 comprises the first deforming plate 5, the second deforming plate 3, O-rings 14, 17 made of insulating resin, supports 11, 20, and a protrusion 12. A conductive part 4 provided at an end of the first conductive member 68 is inserted in the current interruption device 220. The first deforming plate 5 is electrically connected to the first electrode terminal 19 via a sealing lid 7. The first deforming plate 5, the conductive part 4, and the second deforming plate 3 are arranged in this order in a direction from a first electrode terminal 19 side toward the electrode assembly 60 side (in a downward direction in FIG. 8). The O-ring 17 is interposed between the first deforming plate 5 and the conductive part 4, and the O-ring 14 is interposed between the conductive part 4 and the second deforming plate 3. A space 240 is formed by the second deforming plate 3, the first deforming plate 5, the O-rings 14, 17, and the supports 11, 20.

The second deforming plate 3 is a diaphragm made of copper or a copper alloy, is fixed by the support 11 at an outer circumferential part of the second deforming plate 3, and is sealed to the electrode assembly 60 side by the O-ring 14. The protrusion 12, which has insulation properties and protrudes toward the conductive part 4, is provided in a central part of the second deforming plate 3. The protrusion 12 has a tubular shape, and has a contact part 24 which is a surface of the protrusion 12 that faces the conductive part 4. A lower surface side of the second deforming plate 3 that is opposed to the surface on which the protrusion 12 is placed is a pressure receiving part 22, which is planar.

The conductive part 4 of the first conductive member 68 has a central part 15 thinly formed. The central part 15 is located above the contact part of the protrusion 12 of the second deforming plate 3, with a break groove 16 formed in a lower surface of the central part 15. An upper surface of the central part 15 is a bonding part 6. The conductive part 4 is in contact with the first deforming plate 5 at the bonding part 6.

The first deforming plate 5 is a diaphragm made of copper or a copper alloy, and is fixed by the support 11 at an outer circumferential part of the first deforming plate 5. The first deforming plate 5 is in contact with the bonding part 6 of the conductive part 4 at a bonding part 23 on a lower surface of a central part of the first deforming plate 5. The bonding part 6 of the conductive part 4 and the bonding part 23 of the first deforming plate 5 are fixed to each other by welding and electrically connected to each other.

A first spacer 260 is fixed to a lower part of the second deforming plate 3. An upper surface of the first spacer 260 has a shape corresponding to a shape of a lower surface of the second deforming plate 3. As in the case of the first spacer 150 according to Embodiment 1, the lower surface of the first spacer 260 (i.e., a surface that is in contact with the electrode assembly 60) has a shape corresponding to a shape of a surface (i.e., the surface 60a shown in FIGS. 1 and 2) of the electrode assembly 60 on a first spacer 260 side. The first spacer 260 is a substantially ring-shaped member having a through-hole in a center thereof in a plan view, and is made of an insulating material. The first spacer 260 is fixed to the current interruption device 220 so that the through-hole is located below the pressure receiving part 22 of the second deforming plate 3. The pressure receiving part 22 faces the electrode assembly 60 side within the casing 1 via the through-hole of the first spacer 260.

A sealing member 10, that has insulation properties, is fitted between an upper surface of the sealing lid 7 and an inner surface of the casing 1 so that the sealing lid 7 and the casing 1 are electrically insulated from each other. The support 11 has insulation properties, is formed by a resin mold, and is in the shape of a ring having a substantially U-shaped cross-section. The support 11, with its substantially U-shaped inner surface, covers an outer circumferential part of the first spacer 260, the outer circumferential part of the second deforming plate 3, the O-rings 14, 17, an outer circumferential part of the conductive part 4, the outer circumferential part of the first deforming plate 5, and an outer circumferential part of the sealing lid 7 such that these members are sandwiched in a laminated manner and held integrally. It should be noted that the O-rings 14, 17 and the support 11 have insulation properties, that the second deforming plate 3 and the conductive part 4 are insulated from each other, and that the first deforming plate 5 and the conductive part 4 of the first conductive member 68 are insulated from each other at parts other than the bonding parts 6, 23. The support 11 has its outer surface covered with the support 20, which is a caulking member made of metal, to ensure the sealing and the holding. Further, an inner surface part of the sealing lid 7 is formed as a recess 18 depressed upward to form the space 240 in a case where the first deforming plate 5 is deformed upward by the protrusion 12 of the second deforming plate 3.

The conductive part 4 of the first conductive member 68, the first deforming plate 5, and the sealing lid 7 are connected in series in this order from the electrode assembly 60 toward the first electrode terminal 19. The first electrode terminal 19 and the first conductive member 68 are electrically connected to each other via the first deforming plate 5 of the current interruption device 220. During normal operation of the electric storage device, as shown in FIG. 8, the contact part 24 of the protrusion 12 is not in contact with the conductive part 4. That is, the negative-electrode-side conductive path is connected.

During overcharging of the electric storage device, as shown in FIG. 9, the second deforming plate 3 is deformed toward the conductive part 4, and the contact part 24 of the protrusion 12 makes contact with a lower surface of the central part of the conductive part 4 to break the conductive part 4 at the break groove 16 to separate the central part of the conductive part 4 from the conductive part 4. This causes the bonding part 6 and the bonding part 23 to be separated and set apart from the conductive part 4 to interrupt the electrical connection between the current interruption device 220 and the first conductive member 68, resulting in the negative-electrode-side conductive path being interrupted.

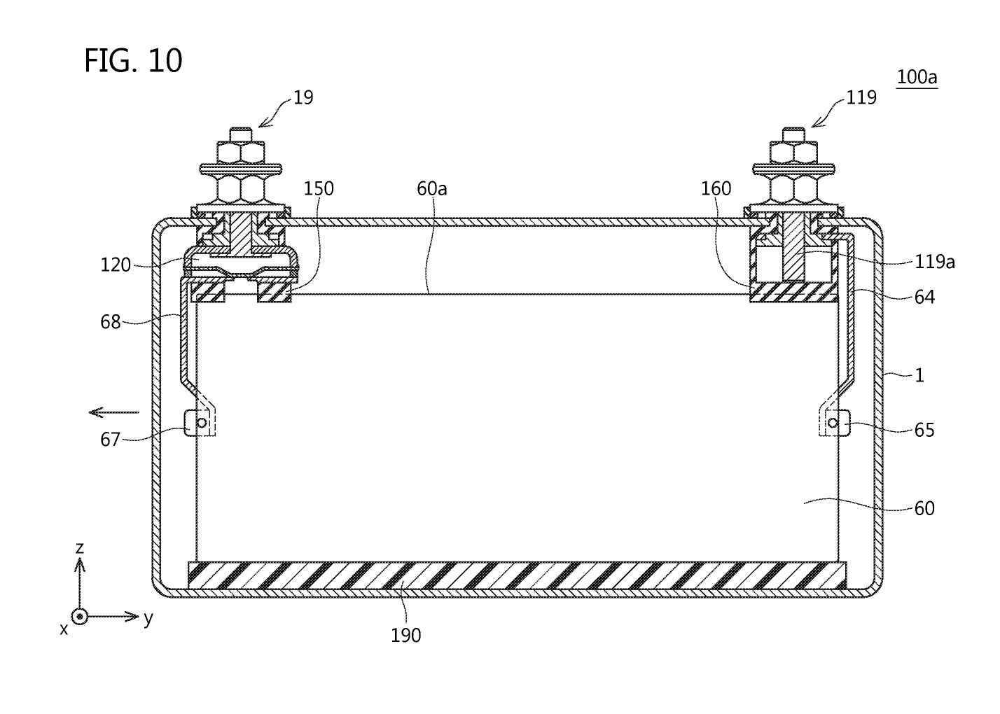

Further, in another modification, as in the case of an electric storage device 100a shown in FIG. 10, a shock-absorber 190 may be placed between a wall surface opposed to the terminal attachment wall of the casing 1 and the electrode assembly 60. As a material of which the shock-absorber 190 is made, an insulating and elastic resin material may be suitably used. Descriptions of components of the electric storage device 100a other than the shock-absorber 190 will be omitted here, as they are identical to those of the electric storage device 100 shown in FIG. 1, etc. When the electrode assembly 60 is inserted into the casing 1, since the electrode assembly 60 makes contact with the shock-absorber 190, which is elastic, even when the electrode assembly 60 is deeply inserted into the casing 1. Due to this, as compared with a case where the electrode assembly 60 makes direct contact with the wall surface opposed to the terminal attachment wall of the casing 1, the reaction force that is generated by the contact can be reduced.

In the embodiment and modifications described above, the current interruption device is arranged on the negative-electrode-side conductive path. Alternatively, the current interruption device may be arranged on a positive-electrode conductive path. Further, the first spacer may not need to be fixed to the current interruption device. Similarly, the second spacer may not need to be fixed to the second electrode terminal.

Further, the surface of the first spacer which makes contact with the electrode assembly may not need to have a shape corresponding to the shape of the surface of the electrode assembly on the first spacer side. For example, in a case where the surface of the electrode assembly on the first spacer side has an R-shape as shown in FIG. 2, the surface of the first spacer which makes contact with the electrode assembly may be flat. Similarly, the surface of the second spacer which makes contact with the electrode assembly may not need to have a shape corresponding to the shape of the surface of the electrode assembly on the second spacer side.

Specific examples of the present invention are described above in detail, but these examples are merely illustrative and place no limitation on the scope of the patent claims. The technology described in the patent claims also encompasses various changes and modifications to the specific examples described above.

The technical elements explained in the present disclosure or drawings provide technical utility either independently or through various combinations. The present invention is not limited to the combinations described at the time the claims are filed. Further, the purpose of the examples shown by the present disclosure or drawings is to satisfy multiple objectives simultaneously, and satisfying any one of those objectives gives technical utility to the present invention.

1. An electric storage device comprising:
a casing including a terminal attachment wall;
an electrode assembly disposed within the casing and comprising a positive electrode and a negative electrode;
a first electrode terminal and a second electrode terminal that are provided on the terminal attachment wall which is one of a plurality of walls that configures the casing;
a first conductive member disposed within the casing and electrically connected to one of the positive electrode and the negative electrode;
a second conductive member disposed within the casing and electrically connected to both the positive electrode assembly and the second electrode terminal;
a current interruption device arranged between the terminal attachment wall and the electrode assembly, disposed within the casing, connected in series between the first electrode terminal and the first conductive member, and configured to connect or interrupt a conductive path from the electrode assembly to the first electrode terminal, and
a first spacer arranged between the current interruption device and the electrode assembly.

2. The electric storage device according to claim 1, wherein
the first spacer is fixed to the current interruption device.

3. The electric storage device according to claim 1, wherein
the first spacer comprises a surface which makes contact with the electrode assembly, the surface having a shape corresponding to a shape of a surface of the electrode assembly on a first spacer side.

4. The electric storage device according to claim 1, further comprising a second spacer arranged between the second electrode terminal and the electrode assembly, the second spacer being in contact with the electrode assembly.

5. The electric storage device according to claim 4, wherein
the second spacer is fixed to the second electrode terminal.

6. The electric storage device according to claim 1, wherein
the second spacer comprises a surface which makes contact with the electrode assembly, the surface having a shape corresponding to a shape of a surface of the electrode assembly on a second spacer side.

7. The electric storage device according to claim 1, further comprising a shock-absorber arranged between the electrode assembly and a wall surface opposed to the terminal attachment wall of the plurality of the walls that configures the casing.

8. The electric storage device according to claim 1, wherein
the electric storage device is a secondary battery.

9. The electric storage device according to claim 1, wherein
the current interruption device comprises a deforming plate including a pressure receiving part configured to receive pressure inside the casing, and is configured to interrupt the conductive path when the pressure inside the casing that is acting on the pressure receiving part increases and the deforming plate is deformed, and
a through-hole is provided in the first spacer, and the pressure inside the casing acts on the pressure receiving part of the deforming plate via the through-hole.

10. The electric storage device according to claim 9, wherein
in a plan view of the current interruption device and the first spacer, the pressure receiving part of the deforming plate and the through-hole of the first spacer overlap.

11. The electric storage device according to claim 1, wherein
the current interruption device comprises a deforming plate configured to receive pressure inside the casing and a support supporting the deforming plate, and is configured to interrupt the conductive path when the pressure inside the casing that is acting on the deforming plate increases and the deforming plate is deformed, and
in a plan view of the deforming plate and the first spacer, a position of an outer peripheral edge of the first spacer is located on an inner side than a position of an outer peripheral edge of the deforming plate.

12. The electric storage device according to claim 11, wherein
in the plan view of the deforming plate and the first spacer, the position of the outer peripheral edge of the first spacer matches with or is located on an outer side than, within a part of the deforming plate that is opposed to the electrode assembly, a position of a part of the deforming plate that is not supported by the support.

13. The electric storage device according to claim 11, wherein
a through-hole is provided in the first spacer, and
in a plan view of the current interruption device and the first spacer, the through-hole of the first spacer is located in a central part of the deforming plate.

14. The electric storage device according to claim 1, wherein
the electrode assembly further comprises a pair of electrodes in which a positive-electrode sheet, a separator and a negative-electrode sheet are laminated, a positive-electrode current collector connected to the positive-electrode sheet of the pair of electrodes, and a negative-electrode current collector connected to the negative-electrode sheet of the pair of electrodes,
the first conductive member is connected to one of the positive-electrode current collector and the negative-electrode current collector,
the second conductive member is connected to the other of the positive-electrode current collector and the negative-electrode current collector,
the casing comprises a pair of opposed walls which are opposed to each other and extend from an outer peripheral edge of the terminal attachment wall to an electrode assembly side,
the positive-electrode current collector protrudes from the pair of electrodes toward one of the pair of opposed walls, and
the negative-electrode current collector protrudes from the pair of electrodes toward the other of the pair of opposed walls.

15. The electric storage device according to claim 1, wherein
the first spacer adheres to the current interruption device.

16. The electric storage device according to claim 15, wherein
a surface of the first spacer which makes contact with the electrode assembly has a shape corresponding to a shape of a surface of the electrode assembly on a first spacer side.

17. The electric storage device according to claim 1, wherein
the electrode assembly comprises a pair of electrodes in which a positive-electrode sheet, a separator and a negative-electrode sheet, and the pair of electrodes is wound around a winding axis which is parallel to the terminal attachment wall, and
a surface of the first spacer on an electrode assembly side has a concave R-shape corresponding to a shape of a surface of the electrode assembly on a first spacer side.

18. The electric storage device according to claim 1, wherein
a through-hole passing from a surface of the first spacer on an electrode assembly side to a surface of the first spacer on a current interruption device side is provided in the first spacer.
